(19) United States
(12) Patent Application Publication
(10) Pub. No.: US 2008/0101566 A1
(43) Pub. Date: May 1, 2008

(54) METHOD TO PLAY VENDOR VIDEOS

(76) Inventors: Jonathan William Medved, Jerusalem (IL); Steven Charles Glanz, Bet Shemesh (IL); David Elliot Goldfarb, Bet Shemesh (IL)

Correspondence Address: DANIEL J SWIRSKY, 55 REUVEN ST., BEIT SHEMESH, 99544, omitted

(21) Appl. No.: 11/923,831

(22) Filed: Oct. 25, 2007

Related U.S. Application Data
(60) Provisional application No. 60/862,991, filed on Oct. 26, 2006.

(51) Int. Cl. H04M 11/00

(52) U.S. Cl. 379/93.25

(57) ABSTRACT

A method includes identifying that the destination phone number of a call made by a communications device is to a vendor and playing a video clip associated with said vendor on said communications device during said call. Another method includes storing videos associated with a multiplicity of vendors, receiving a phone number associated with one of said vendors from a communications device, and providing a video associated with said vendor to said communications device. The invention also includes the device and server implementing the methods.

### CROSS-REFERENCE TO RELATED APPLICATIONS

This application claims benefit from U.S. Provisional Patent Application No. 60/862,991, filed Oct. 26, 2006 which is hereby incorporated in its entirety by reference.

### FIELD OF THE INVENTION

The present invention relates to cellular telephones generally and to the playing of vendor provided content in particular.

### BACKGROUND OF THE INVENTION

Customers often call vendors to order items or to ask questions of service representatives. Most vendors have IVR (interactive voice response) systems that either provide requested information to the calling customer or which direct the customer to the appropriate service representatives. While such IVR systems save time and manpower for the call centers that receive the calls, they can be very frustrating for a customer trying to get an answer to a particular question or trying to order a particular item.

Navigating IVR systems can be time consuming. A customer calling in to an IVR will often have to listen to, and then respond to several automated prompts before receiving the required response to a relatively simple inquiry. It is also not unusual for the customer to navigate through several layers of responses before hitting a dead end and having to start over. And even after the “IVR labyrinth” has been successfully navigated, customers often find themselves waiting on-hold for the vendor's customer service agent.

PCT Publication WO 2007/013075, assigned to the common assignees of the present invention and incorporated herein by reference, discloses a synchronized voice and data system which enables a customer to navigate an IVR system with a standard web browser instead of, or in addition to, a voice connection. The visual features of the browser make it easier for some customers to understand the IVR options, thus lessening their frustration while navigating. Using a browser also enables a customer to browse promotional/service material on a vendor's website while waiting on-hold for a service representative to answer. Customers thus are more likely to feel that their time is being put to good use and not wasted.

### SUMMARY OF THE PRESENT INVENTNION

There is provided, in accordance with a preferred embodiment of the present invention, a method including identifying that the destination phone number of a call made by a communications device is to a vendor and playing a video clip associated with the vendor on the communications device during the call.

Additionally, in accordance with a preferred embodiment of the present invention, the method includes requesting the video clip from a vendor video server, the request including at least the destination phone number.

Moreover, in accordance with a preferred embodiment of the present invention, the method including utilizing the destination phone number to retrieve the video clip from a video storage unit on the device.

Further, in accordance with a preferred embodiment of the present invention, the playing occurs while the call is on hold. The playing may include repeating the video clip. In one embodiment, the repeating includes continuing until a stop button is pressed, the call ends or an audio response from the vendor is received.

Still further, in accordance with a preferred embodiment of the present invention, the playing includes playing the video silently.

There is also provided, in accordance with a preferred embodiment of the present invention, a method including storing videos associated with a multiplicity of vendors, receiving a phone number associated with one of the vendors from a communications device and providing a video associated with the vendor to the communications device.

Moreover, in accordance with a preferred embodiment of the present invention, the providing includes selecting a vendor video clip associated with the phone number and downloading the selected vendor video clip to the device.

Further, in accordance with a preferred embodiment of the present invention, the selecting includes receiving customer call information from the vendor associated with a current call from the device to the vendor and processing the information to determine which of the vendor video clips to download.

Still further, in accordance with a preferred embodiment of the present invention, the information is at least one of an on-hold estimate, customer call history details and a customer interest prediction.

There is also provided, in accordance with a preferred embodiment of the present invention, a communications device including a media player, means for detecting a phone number of an outgoing phone call from the device and a vendor video client to determine that the phone number is to a vendor and to play at least one vendor video on the media player during the call. The vendor video is associated with the phone number.

Additionally, in accordance with a preferred embodiment of the present invention, the device includes a video requester to send a request for the vendor video to a vendor video server, wherein the request is associated with the detected phone number and a video receiver to receive the vendor video from the server in response to the request.

Further, in accordance with a preferred embodiment of the present invention, the device also includes a unit for storing the at least one vendor video and a unit for associating each the vendor video with an associated phone number.

There is also provided, in accordance with a preferred embodiment of the present invention, a video vendor server including a storage unit to store video clips associated with a multiplicity of vendors, a request receiver to receive a phone number associated with one of the vendors from a communications device and a video downloader to provide a video clip associated with the vendor to the communications device.

Moreover, in accordance with a preferred embodiment of the present invention, the downloader includes a selector to select a vendor video clip associated with the phone number and a downloader to download the selected vendor video clip to the device.

Additionally, in accordance with a preferred embodiment of the present invention, the server includes an information receiver to receive customer call information from the vendor associated with a current call between the device and the vendor and an information processor to determine which of the vendor video clips to download.

There is also provided, in accordance with a preferred embodiment of the present invention, a method including storing videos associated with a multiplicity of vendors, receiving, from one of the vendors, a phone number of a communications device currently communicating with the vendor and providing a video associated with the vendor to the communications device.

Moreover, in accordance with a preferred embodiment of the present invention, the providing includes selecting a vendor video clip associated with the vendor and downloading the selected vendor video clip to the device.

Finally, in accordance with a preferred embodiment of the present invention, the selecting includes receiving customer call information from the vendor associated with a current call from the device to the vendor and processing the information to determine which of the vendor video clips to download.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a novel system for the playing of vendor videos, constructed and operative in accordance with a preferred embodiment of the present invention; and

FIG. 2 is a schematic illustration of an alternative preferred configuration of the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

At some point before or during an IVR session, a customer may typically have to wait on-hold for a response from the IVR or a customer service representative. During these moments, the customer's “audio attention” is occupied. However, while the customer may have to listen for a response, his/her other senses may not be similarly occupied. For example, the customer may listen with “half an ear” but otherwise occupy him/herself with reading a book or watching television.

Applicants have realized that a vendor may take advantage of this situation by providing videos to customers while they wait for an audio response on the telephone. The videos may be advertisements, infomercials or any other video which the vendor may want the customer to see while the customer is either talking to a customer service agent or while the customer is on hold. For example, if the customer is calling a car rental agency, the video may show the different cars that are available for the customer to choose. Or, the video may show the car and/or rental plan that the vendor is currently pushing. These videos may be viewed not only while on hold but also during the rest of a call as well.

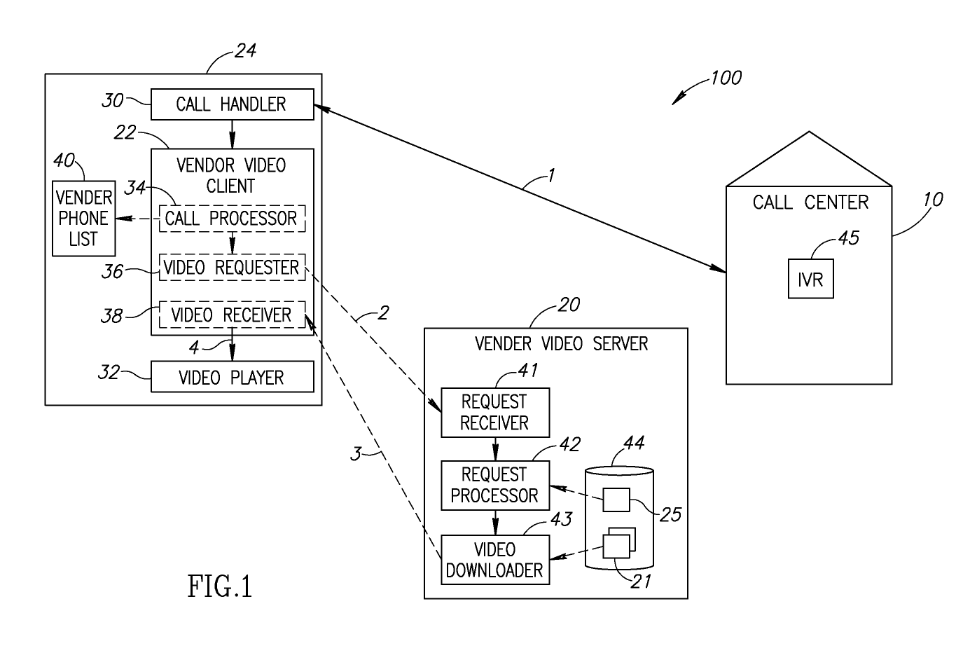

Reference is now made to FIG. 1, which illustrates a novel system 100 for providing video to a customer while s/he is on the phone to a vendor or call center 10. The system may comprise a vendor video server 20, which may be external to call center 10, and a vendor video client 22 installed on a communications device 24. Communications device 24 may be a 3G mobile telephone, such as is pictured in FIG. 1, or any other telephone which may have both a voice and a data channel and may be capable of playing video. Communications device 24 may also be, for example, a videophone, or a voice over IP (VoIP) phone with a video capability, such as the Skype VoIP computer telephone applications.

Communications device 24 may also comprise both a voice call handling unit 30, a video player 32 and a vendor phone list 40. Vendor video client 22 may monitor each of the telephone numbers dialed by unit 30 and check if vendor phone list 40 contains a match for a dialed number. U.S. patent application Ser. No. 11/544,938, assigned to the common assignees of the present invention and incorporated herein by reference, discloses a method and system for monitoring and processing the telephone numbers of outgoing phone calls from communication devices such as communications device 24. It will be appreciated that the phone numbers for the outgoing phone calls may be “dialed” manually by a user or input by reference via, for example, a contact list.

Returning to FIG. 1, vendor video client 22 may comprise a call processor 34, a video requester 36 and a video receiver 38. Arrow 1 represents an outgoing call from call handler 30 to a call center 10, where the call may be routed to an IVR 45. Call processor 34 may trap the dialed number and check for a match on vendor phone list 40. If a match for the dialed number may be found, video requester 36 may then send a message (arrow 2) to vendor video server 20, requesting a download of a current video 21 associated with the dialed number. The message may indicate the dialed phone number as well as the connection information for the data channel of communications device 24. It will be appreciated that the message may be sent via any suitable technology, for example, via an Internet connection or SMS.

Vendor video server 20 may comprise a request receiver 41, a request processor 42, a video downloader 43 and a data storage unit 44. Data storage unit may store a vendor video index 25 and at least one vendor video 21. Vendor video index 25 may associate each vendor video 21 with one or more phone numbers of call center 10. In general, the vendors may supply vendor videos 21 to vendor video server 20. However, the present invention also incorporates receiving videos 21 from competitors or from partners of the vendors. In all cases, vendor video index 25 associates the videos 21 with the phone number(s) of call center 10.

Request receiver 41 may receive the request from video requester 36 and forward it to request processor 42 for processing. Request processor 42 may use the phone number indicated on the request to lookup an associated vendor video 21.

Video downloader 43 may then download (arrow 3) associated vendor video 21 along the data channel of communications device 24. Once video receiver 38 begins to receive the download, vendor video client 22 may activate (arrow 4) video player 32 to start playing downloaded associated vendor video 21. The playing may begin after video 21 is downloaded or once a sufficient amount of data has been downloaded. It will be appreciated that depending on the capabilities of communications device 24 “streaming video” may also be used to play video 21.

An exemplary video may be very short, such as half a minute, and video player 32 may repeat it until either the call ends or until the customer presses a stop button. It will be appreciated that the playing of video 21 may not require that the call be answered by call center 10. Video player 32 may begin playing video 21 before the call is answered, while the call is still “ringing” at call center 10.

Vendor phone list 40 may be periodically updated by downloading a new version from vendor video server 20. Alternatively, vendor phone list 40 may be located on server 20 and vendor video client 22 may send server 20 a message with a phone number for each of the outgoing phone calls from communications device 24.

It will be appreciated that communications device 24 may not comprise the functionality required to detect the end of a call, and thus vendor video client may require “waking up” in order to stop playing video 21 at the end of the call. U.S. patent application Ser. No. 11/853,117, assigned to the common assignees of the present invention and hereby incorporated in its entirety by reference, discloses an operator-hosted SMS wakeup system that may be configured to wake up client 22 at the end of the call.

It will be appreciated that video 21 may be downloaded and played while the customer is on the phone with the vendor, (e.g. to call center 10). Thus, while the customer is either on hold or while s/he is talking to the customer service agent, the customer may see video 21 on media player 32. Since the customer may be using the voice channel for the call to call center 10, the video may be silent, possibly with subtitles or other wording on it, as desired.

U.S. patent application Ser. No. 11/544,938 discloses a method and system for providing media clips to a communications device and then playing them on the occasion of calls to and from buddies. In accordance with an alternative preferred embodiment of the present invention, video 21 may be stored on communications device 24 prior to a call to call center 10. Vendor video client 22 may play a stored video without sending a message to server 20 and downloading video 21.

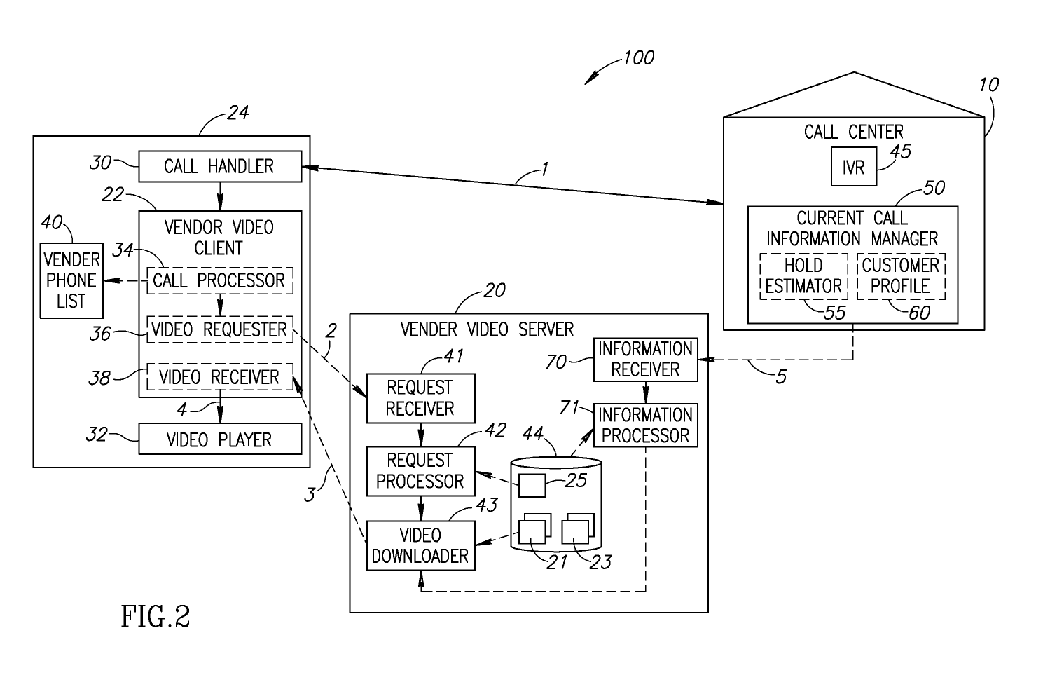

In accordance with an alternative preferred embodiment of the present invention, the specific video downloaded by server 20 may depend on information provided by call center 10. FIG. 2, to which reference is now made, shows system 100 configured to provide such information to vendor video server 20.

Vendor video server 20 may store more than a single video for each associated call center 10. For example, as illustrated in FIG. 2, videos 21 and 23 may be associated with call center 10. Vendor video server 20 may download either or both of videos 21 and 23 to communications device 24 based on information received from call center 10. As will be discussed hereinbelow, such information may include, for example, the estimated length of time a customer call may be on hold, details regarding the progress of the current call, and/or details from the current customer's purchasing/service history.

In addition to IVR 45, call center 10 may also comprise a current call information manager 50 to provide current call information regarding the current call to vendor video server 20. Current call information manager 50 may send this information to vendor video server 20 when an IVR session is initiated or the caller is on put on hold. Alternatively, vendor video server 20 may contact current call information manager 50 to request current call information when vendor video client 22 may request a download (arrow 2). It will be appreciated that vendor video server 20 may provide a download either from a request from video requester 36 or upon information received from current call information manager 50. For the latter, manager 50 may provide at least the phone number of communications device 24.

Current call information manager 50 may comprise a hold estimator 55 to estimate the length of time a given customer call may be on hold. It will be appreciated that hold estimators are known in the art and are typically used to inform customers how long they can expect to wait before receiving service. Hold estimator 55 may estimate how long a current call with communications device may be on-hold. Manager 50 may send this estimate to vendor video server 20.

Video vendor server 20 may also comprise an information receiver 70 and an information processor 71. Information receiver 70 may receive information, for example, a telephone number, an on-hold estimate, etc., from current call information manager 50. Information receiver 70 may forward this information to information processor 71 for processing.

Videos 21 and 23 may be of different lengths. For example, video 21 may be 30 seconds long and video 23 may be 60 seconds long. If, for example, the estimate received from manager 50 was less than a minute, information processor 71 may select video 21 for downloading to communications device 24. If the estimate was that the customer may be on hold for longer than a minute, information processor 71 may instead select video 23. Video downloader 43 may then download either video 21 or video 23 in accordance with the selection by information processor 71.

Current call information manager 50 may also comprise a customer profiler 60. IVR 45 may forward a current caller's “caller ID” to customer profiler 60, which may use it to look up a customer's history. Customer profiler 60 may analyze the details of customer's purchasing and/or service history with call center 10 and may predict what products and/or services may interest the customer. Customer profiler 60 may also analyze any selections that a customer has already made during a given IVR session and, based on this analysis, predict what products and/or services may currently be of interest to the customer. Alternatively, based on this analysis, customer profiler 60 may provide information to upsell or cross-sell additional services tailored to the customer's profile. These services may be shown in one of videos 21 and 23 and may include a coupon or special offer. Manager 50 may send this information to information receiver 70.

Videos 21 and 23 may describe different products and/or services. For example, the vendor may be an auto dealership and video 21 may describe a new car for sale. Video 23 may include a list of garages with which the vendor has a servicing agreement. If, for example, the prediction received from manager 50 indicated that the customer may be likely to be interested in buying a new car, information processor 71 may indicate video 21 for download. If the prediction was that the customer may probably be calling because of problems with a car that he may have already bought from the dealership, information processor 71 may indicate video 23.

Vendor video server 20 may also personalize videos 21 and 23 based on information received from manager 50. For example, customer profiler 60 may identify a caller as a member of a frequent flier program and forward the account number and balance to server 20. This information may then be used to personalize videos 21 and/or 23 prior to download.

Vendor video server 20 may also download a multiplicity of vendor videos, for example, both video 21 and 23. Server 20 may download video 21 in response to a download request received from vendor video client 22. Server 20 may then receive current call information from current call information manager 50 that may indicate a particular interest of the customer. After processing this information, server 20 may, for example, select video 23 as more suitable for the customer. Server 20 may then download video 23 to be played instead of or after video 21.

In accordance with an alternative preferred embodiment of the present invention, videos 21 and/or 23 may include instructions or a linked URL to initiate a synchronized voice and data session as disclosed in PCT Patent Application IL2006/000868.

It will be appreciated that the present invention enables vendors to entertain their customers during customer service conversations. The videos may be entertaining or may provide information to the customers that may be useful for the customer service conversation. It will further be appreciated that the playing of videos 21 and 23 may not be limited to playing during on-hold states. They may begin to play before call center 10 even answers the incoming call, and may continue until or beyond the end of the call, regardless of whether or not the customer was ever put on hold.

It will further be appreciated that vendor video server 20 may also store a customer history. In this embodiment, the history may be of which vendors communications device 24 called and how recently. Vendor video server 20 may review such history upon each call by communications device 24 and may have heuristics as to which video to supply based on this information. For example, a user of device 24 may be planning a vacation and may have called an airline and a hotel. Based on this information, vendor video server 20 may select a video of a vacation type car when device 24 requests a video for a car rental agency.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
identifying that the destination phone number of a call made by a communications device is to a vendor; and
playing a video clip associated with said vendor on said communications device during said call.

2. The method according to claim 1 and also comprising:
requesting said video clip from a vendor video server, said request including at least said destination phone number.

3. The method according to claim 1 and also comprising:
utilizing said destination phone number to retrieve said video clip from a video storage unit on said device.

4. The method according to claim 1 and wherein said playing occurs while said call is on hold.

5. The method according to claim 1 and wherein said playing comprises repeating said video clip.

6. The method according to claim 5 and wherein said repeating comprises continuing until one of the following actions occur: a stop button is pressed, the call ends and an audio response from said vendor is received.

7. The method according to claim 1 and wherein said playing comprises playing said video silently.

8. A method comprising:
storing videos associated with a multiplicity of vendors;
receiving a phone number associated with one of said vendors from a communications device; and
providing a video associated with said vendor to said communications device.

9. The method according to claim 8 and wherein said providing comprises:
selecting a vendor video clip associated with said phone number; and
downloading said selected vendor video clip to said device.

10. The method according to claim 9 and wherein said selecting comprises:
receiving customer call information from said vendor associated with a current call from said device to said vendor; and
processing said information to determine which of said vendor video clips to download.

11. The method according to claim 10 and wherein said information is at least one of: an on-hold estimate, customer call history details and a customer interest prediction.

12. A communications device comprising:
a media player;
means for detecting a phone number of an outgoing phone call from said device and
a vendor video client to determine that said phone number is to a vendor and to play at least one vendor video on said media player during said call,
wherein said vendor video is associated with said phone number.

14. The device according to claim 12 and also comprising:
a video requester to send a request for said vendor video to a vendor video server, wherein said request is associated with said detected phone number; and
a video receiver to receive said vendor video from said server in response to said request.

15. The device according to claim 12 and also comprising:
means for storing said at least one vendor video; and
means for associating each said vendor video with an associated phone number.

16. A video vendor server comprising:
a storage unit to store video clips associated with a multiplicity of vendors;
a request receiver to receive a phone number associated with one of said vendors from a communications device; and
a video downloader to provide a video clip associated with said vendor to said communications device.

17. The server according to claim 16 and wherein said downloader comprises:
a selector to select a vendor video clip associated with said phone number; and
a downloader to download said selected vendor video clip to said device.

18. The server according to claim 16 and also comprising:
an information receiver to receive customer call information from said vendor associated with a current call from said device to said vendor; and
an information processor to determine which of said vendor video clips to download.

19. The server according to claim 18 wherein said information is at least one of: an on-hold estimate, customer call history details and a customer interest prediction.

20. A method comprising:
storing videos associated with a multiplicity of vendors;
receiving, from one of said vendors, a phone number of a communications device currently communicating with said vendor; and
providing a video associated with said vendor to said communications device.

21. The method according to claim 20 and wherein said providing comprises:
selecting a vendor video clip associated with said vendor; and
downloading said selected vendor video clip to said device.

22. The method according to claim 21 and wherein said selecting comprises:
receiving customer call information from said vendor associated with a current call from said device to said vendor; and
processing said information to determine which of said vendor video clips to download.

23. The method according to claim 22 and wherein said information is at least one of: an on-hold estimate, customer call history details and a customer interest prediction.
